(19) United States
(12) Patent Application Publication
(10) Pub. No.: US 2022/0203260 A1
(43) Pub. Date: Jun. 30, 2022

(54) CONTAINMENT DEVICE FOR A ROTARY EVAPORATOR

(71) Applicant: LES LABORATOIRES SERVIER, Suresnes Cedex (FR)

(72) Inventors: Jean-Baptiste Gandar, Fontaine La Mallet (FR); Christophe Besseyre, Gonfreville Caillot (FR); Bruno Aubry, Saint-Pierre-des-Fleurs (FR); Samuel Lapert, Rocquefort (FR)

(73) Assignee: LES LABORATOIRES SERVIER, Suresnes Cedex (FR)

(21) Appl. No.: 17/429,600

(22) PCT Filed: Feb. 4, 2020
(86) PCT No.: PCT/EP2020/052751

§ 371 Date: Aug. 9, 2021

(30) Foreign Application Priority Data
Feb. 14, 2019 (FR) 1901529

(51) Int. Cl. B01D 3/08; B01D 5/00

(52) U.S. Cl. CPC B01D 3/085; B01D 5/0051; B01D 5/0045; B01D 5/006

(57) ABSTRACT

Disclosed is a removable containment device for a rotary evaporator, comprising: a first end (12) for sealed connection to a rotation shaft (3) of the rotary evaporator (1); a second end (13) for sealed connection to a container (2) for receiving a mixture to be evaporated; and a body (11) in fluid connection with the first and second sealed connection ends (12, 13) comprising a valve system (14) for the selective passage between the first and second ends (12, 13) of the evaporating constituent of the mixture to be evaporated.

The present invention relates, in general terms, to the containment of substances and the evaporation of substances that it is necessary to contain.

More particularly, the invention relates to a containment device for a rotary evaporator as well as a rotary evaporator comprising such a containment device.

Containment means keeping a substance enclosed in a space, for example in a container or in a clean room, in order to avoid the substance being in contact with the external air.

In the field of organic chemistry, it is conventional to use a rotary evaporator, the principle of which is based on lowering the boiling point, by means of the pressure, to eliminate a solvent from a mixture. Evaporating the solvent makes it possible to concentrate a solution including a product of interest and to isolate this product by drying.

The mixture to be evaporated is placed in a container, generally a flask, which is connected to a drive shaft coupled to a motor for rotating it. The rotation shaft is itself connected to a refrigerator provided with an inlet and an outlet for refrigerating liquid and surmounted by a valve for putting the rotary evaporator under vacuum. The solvent that evaporates is directed to the refrigerator, where it condenses before being collected in a recovery container. To accelerate the evaporation, the flask is generally immersed in a bain marie in order to be heated.

To recover the product remaining after evaporation, the flask is removed from the rotary evaporator.

However, containing the flask is necessary under certain conditions, for example for reasons of safety, because it is necessary to handle the product of interest in a controlled atmosphere, or to avoid loss of product related to handling errors because of the economic value thereof.

Containing an evaporation operation on a rotary evaporator is not easy to achieve as soon as the volume of the flask exceeds a few litres. This is because the size of a rotary evaporator quickly becomes incompatible with containing it in a fume cupboard or in an isolator.

One solution consists in implementing the evaporation in a clean room, but introducing the rotary evaporator into a clean room is difficult since the cleaning intended to avoid the risk of cross-contamination or bacterial contamination is tricky. In addition, such an installation is complex and expensive.

The aim of the invention is therefore to remedy these drawbacks and to propose a device for evaporating a mixture by means of a rotary evaporator to recover a product of interest, while guaranteeing containment of the product of interest, in particular when the container receiving the mixture to be evaporated is removed from the rotary evaporator after evaporation.

A removable containment device for a rotary evaporator is therefore proposed, comprising: a first end for sealed connection to a rotation shaft of the rotary evaporator; a second end for sealed connection to a container for receiving a mixture to be evaporated; and a body in fluid connection with the first and second sealed connection ends including a valve system for the selective passage between the first and second ends of the evaporating constituent of the mixture to be evaporated.

The removable containment device preferably comprises a collar for clamping the second connection end to the container receiving the mixture to be evaporated.

According to one feature, the removable containment device may comprise a means for manual control of the opening and closing of the valve system for the selective passage between the first and second ends of the evaporating constituent of the mixture to be evaporated.

The first and second connection ends and the body are preferably made from a metal material.

According to one embodiment, the containment device comprises a valve system of the plug valve type.

According to another embodiment, the containment device comprises a valve system of the butterfly valve type.

Advantageously, the removable containment device may comprise a removable coupling including a first portion for connection to the second end for sealed connection to the reception container and a second portion with a diameter adapted for connection of the containment device to the rotation shaft.

According to an alternative embodiment, the body is in the form of an assembly of at least two independent components that can be connected sealingly, each of the two components including one of the first and second connection ends and a valve system for the selective passage of an evaporating constituent of the mixture to be evaporated between the two components of the body.

Preferably, the containment device comprises an outlet for cleaning fluid for cleaning one of the ends of the containment device when the containment device is connected to the rotary evaporator.

Preferably, the second connection end comprises a safety valve configured to reduce the pressure when there is overpressure in the reception container.

The invention also relates to a rotary evaporator comprising a rotation shaft for rotating a container for receiving a mixture to be evaporated.

Furthermore, the rotary evaporator comprises a containment device as described previously, disposed between the rotation shaft and the reception container.

Preferably, the containment device comprises a refrigerator, a container for recovering the evaporated constituent and a valve device disposed between the refrigerator and the recovery container.

Preferably, the containment device comprises a refrigerator and a container for recovering the evaporated constituent, the recovery container comprising a vacuum connection.

Other aims, advantages and features will emerge from the following description, given purely for illustration and made with reference to the accompanying drawings, on which:

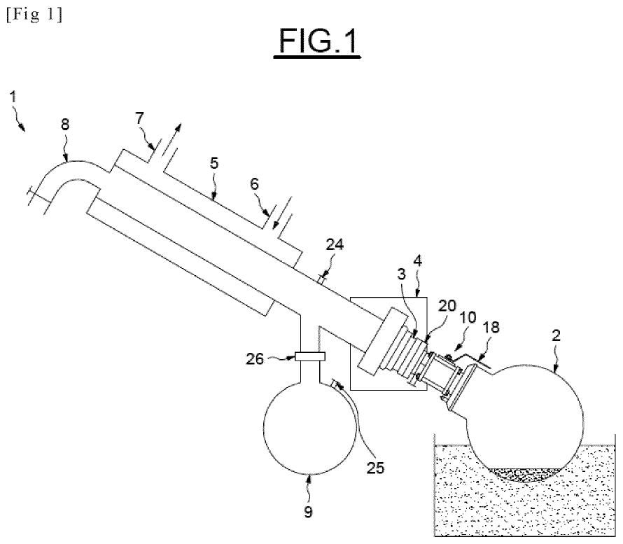

FIG. 1 schematically illustrates a rotary evaporator comprising a containment device according to one embodiment of the invention.

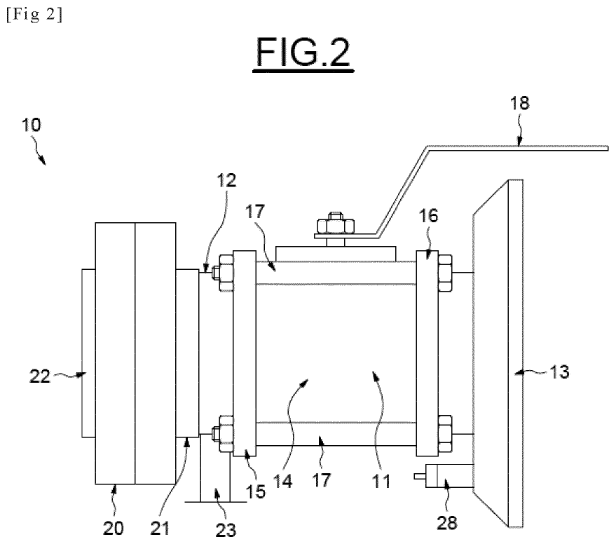

FIG. 2 is a perspective view of a containment device according to one embodiment of the invention.

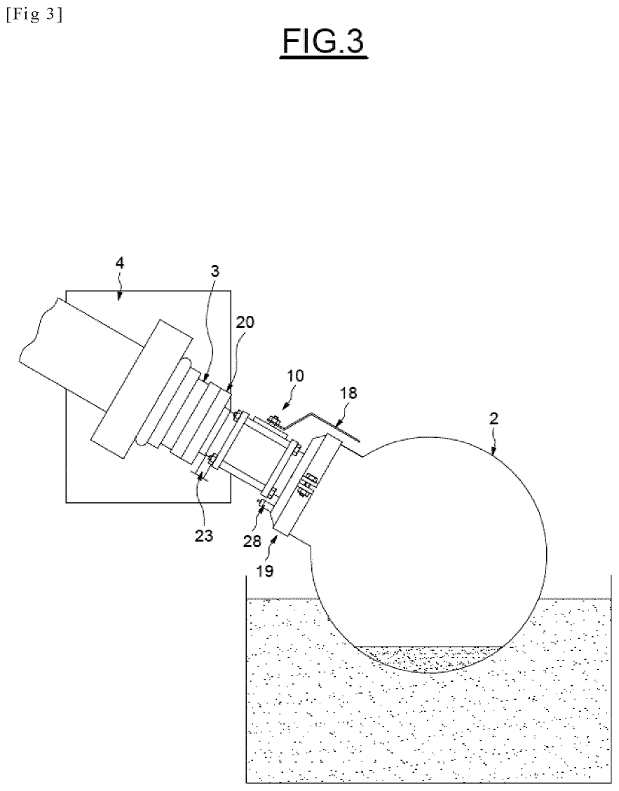

FIG. 3 shows the assembly formed by the containment device illustrated in FIG. 2 and a container for receiving a mixture to be evaporated.

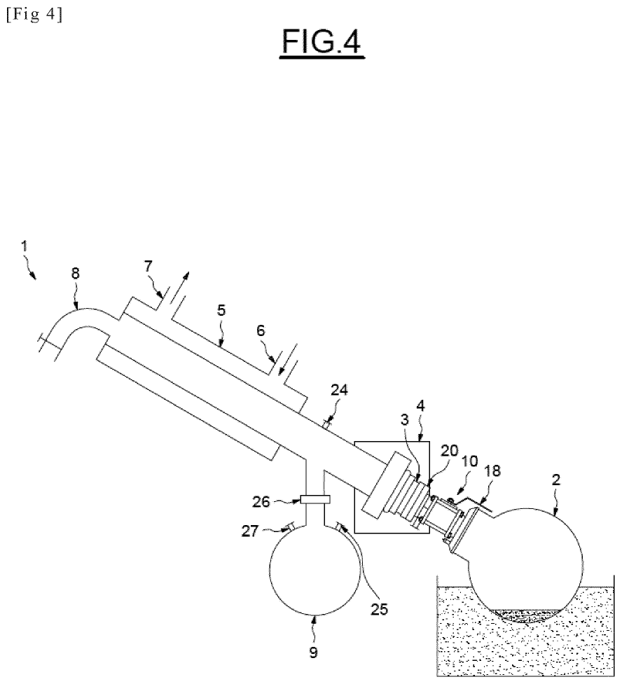

FIG. 4 schematically illustrates a rotary evaporator comprising a containment device according to another embodiment of the invention.

FIG. 1 illustrates a rotary evaporator intended for separating a plurality of constituents of a mixture and designated by the general numerical reference 1.

The rotary evaporator 1 comprises a container 2 for receiving the mixture to be evaporated which, as shown, is preferably a flask. Advantageously, the reception container 2 is immersed in a heating bath.

A rotation shaft 3 is coupled to a motor unit 4 and provides the rotational drive of the container receiving the mixture to be evaporated.

The rotation shaft 3 is surmounted by a refrigerator 5 advantageously provided with an inlet and an outlet for refrigerating liquid, respectively 6 and 7, and an opening 8 for implementing the evaporation under vacuum.

In addition, a recovery container 9 is disposed between the rotation shaft 3 and the refrigerator 5.

The rotary evaporator 1 also comprises a removable containment device 10 disposed between the rotation shaft 3 and the reception container 2.

As can be seen in FIG. 2, the removable containment device 10 comprises a body 11 and first and second connection ends, respectively 12 and 13. In this example, the first and second connection ends 12 and 13 are each connected to the body 11 by a connecting piece welded to the connection end 12, 13 to which it is connected and to the body 11.

The first connection end 12 is intended for connecting the containment device 10 to the rotation shaft 3 of the rotary evaporator 1 and is configured to provide a sealed connection.

The second connection end 13 is intended for connecting the containment device 10 to the container 2 for receiving the mixture to be evaporated and is also configured to provide a sealed connection.

Sealed connection means a connection enabling the evaporating constituent of the mixture to be evaporated to pass from the reception container 2 to the containment device 10 and from the containment device 10 to the rotation shaft 3 without leakage to the outside of the rotary evaporator 1. In this example, the evaporating constituent being a solvent.

The body 11 is advantageously configured to be in fluid connection with the first and second connection ends 12 and 13 and includes a valve system 14. In the example illustrated, the valve system 14 is a plug-valve system.

The plug-valve system 14 is disposed between the first and second ends 12 and 13 for the selective passage of the evaporating constituent of the mixture to be evaporated.

In this way, the constituent that evaporates of the mixture to be evaporated contained in the reception container 2 is directed to the refrigerator 5, where it condenses before being collected in the recovery container 9.

The inside diameter of the containment device 10 that allows the fluid connection between the reception container 2 and the rotation shaft 3 will advantageously be adapted to the rate of evaporation by the rotary evaporator 1.

In the example illustrated, the containment device 10 comprises a single plug-valve system 14, in particular with a spherical plug.

According to an alternative, it will be possible to make provision for the valve system 14 to be a conical-plug system, a butterfly valve or any other suitable valve system, in particular adapted to the flow rate of the evaporating constituent.

The first and second ends 12 and 13 and the body 11 will advantageously be selected in metal material, preferably stainless steel.

In the example illustrated, the body 11 is substantially cylindrical and comprises two flanges 15 and 16, disposed on either side of the valve system 14 and making it possible to clamp the connecting pieces connecting the first and second ends for connecting to the body 11 on the body 11, for example by means of bolts.

In addition, struts 17 centre the body 11.

Furthermore, the containment device 10 may comprise a means 18 for manual control of the opening and closing of the valve system 14 for the selective passage of an evaporating constituent of the mixture to be evaporated between the first and second connection ends 12, 13. The manual control means comprises for example a grip.

FIG. 3 illustrates the assembly formed by the containment device 10 and the reception container 2.

As shown, the containment device 10 may comprise a clamping collar 19 for reinforcing the connection between the second connection end 13 and the reception container 2 by clamping the second connection end 13 on the reception container 2.

Moreover, it will be possible to make provision for the containment device 10 to comprise a removable coupling 20.

Advantageously, the removable coupling 20 includes a first portion 21 connecting the removable coupling 20 to the first connection end 12 and a second portion 22 for connection to the rotation shaft 3 of the rotary evaporator 1 to which the containment device 10 must be connected. The diameter of the second portion 22 of the removable coupling 20 can thus be adapted to the diameter of the rotation shaft 3 to allow connection. This has the advantage of being able to use the same containment device 10 on a plurality of rotary-evaporator profiles and in particular a plurality of diameters of rotation shaft simply by adding the appropriate coupling.

Preferably, the evaporation circuit of the rotary evaporator 1 is placed under static vacuum by means of the opening 8 to allow the introduction of the product through the fluid inlet 24, the containment device being in the open position.

When the evaporator is in operation, the valve system 14 is kept open for the evaporating constituent to pass from the reception container 2 to the rotation shaft 3 and then the refrigerator 5.

When the evaporation has ended, the valve system 14 is closed. To recover the product remaining in the reception container 2 after evaporation of the mixture, the assembly formed by the reception container 2 and the containment device 10 that is removable is removed from the evaporator. In this way, the remaining product is isolated from the external air.

It is then possible to transfer solely the assembly formed by the reception container 2 and the containment device 10 to a fume cupboard, an isolator or a clean room.

According to another embodiment, it will be possible to provide for the containment device 10 to be in the form of an assembly of at least two independent components that can be connected sealingly. One of the two components includes the first end 12 for connection to the reception container 2 and the other component includes the second end 13 for connection to the rotation shaft 3. The components each advantageously comprise a valve system 14 for the selective passage of evaporating constituent of the mixture to be evaporated between the two components of the body.

In this embodiment, when the evaporation has ended, it is possible to close the valve systems 14 of each component and to separate the two components. In this manner, it is possible to keep isolated from the external air both the product remaining after evaporation in the reception container 2 but also the evaporation circuit in the rest of the rotary evaporator 1.

It will also be possible to provide for the containment device 10 to comprise means for cleaning in place for cleaning one of the ends of the containment device 10 after having closed the valve system 14 without its being necessary to remove it from the rotary evaporator 1.

In this regard, and as is illustrated in FIG. 2, the containment device 10 may comprise a cleaning-fluid outlet 23.

Preferably it will be possible to provide for the refrigerator 5 and the recovery container 9 each to comprise a cleaning-fluid inlet, respectively referenced 24 and 25. In FIG. 1, the cleaning-fluid inlets 24 and 25 are shown closed, as is the cleaning-fluid outlet 23 of the containment device 10 in FIG. 2.

Advantageously, the cleaning-fluid outlet 23 is preferably disposed between the valve system 14, here a spherical-plug system, and the first connection end 12.

In this way, after having closed the valve system 14 and previously connected the cleaning-fluid outlet 23 of the containment device 10 with the cleaning-fluid inlet 25 of the recovery container 9 by means for example of a flexible tube, it is possible to supply the cleaning-fluid inlet 24 of the refrigerator 5 with cleaning fluid.

The cleaning fluid, aspirated under vacuum, then flows from the cleaning-fluid inlet 24, advantageously disposed downstream of the rotation shaft 3 of the rotary evaporator 1, to the recovery container 9 by passing through the containment device 10 from the first connection end 12 as far as the cleaning-fluid outlet 23.

The rinsing liquid will advantageously be selected as being the same solvent as the solvent of the mixture to be evaporated.

A purging of a part of the containment device 10 and a cleaning of the supply circuit of the rotary evaporator 1 can thus be implemented.

Such cleaning makes it possible to avoid contamination of the external environment when the assembly formed by the containment device 10, the valve system of which is closed, and the reception container 2 is removed from the rotary evaporator 1.

As is illustrated in FIG. 1, the rotary evaporator 1 also preferably comprises a valve device 26 disposed between the refrigerator 5 and the recovery container 9.

Advantageously, the valve device 26 will be closed during the cleaning step in order to avoid the cleaning fluid being aspirated into the shaft of the refrigerator 5.

Preferably, the recovery container 9 will furthermore comprise a vacuum connection 27, illustrated in FIG. 4, to facilitate and improve the passage of cleaning fluid from the cleaning-fluid inlet 24 to the recovery container 9 during the cleaning step.

In addition, in order to secure the assembly and to avoid any risk of overpressure, the containment device 10 will also be able to comprise a valve 28 illustrated in FIG. 2.

Preferably, the safety valve 28 is disposed on the second connection end 13 and is configured so as to be able to reduce the pressure in the event of overpressure in the reception container 2 to which the second connection end 13 is connected.

The valve 28 makes it possible to avoid overpressure in the reception container 2 to which the containment device 10 is connected. This is particularly advantageous during the cleaning in place of the containment device 10, and when the flask containing the product of interest is transported to the place where it is drained and packaged.

1. Removable containment device for a rotary evaporator, comprising:
a first end (12) for sealed connection to a rotation shaft (3) of the rotary evaporator (1);
a second end (13) for sealed connection to a container (2) for receiving a mixture to be evaporated; and
a body (11) in fluid connection with the first and second sealed connection ends (12, 13) including a valve system (14) for the selective passage, between the first and second ends (12, 13), of an evaporating constituent of the mixture to be evaporated.

2. Device according to claim 1, characterised in that it comprises a collar (19) for clamping the second connection end (13) to the container (2) receiving the mixture to be evaporated.

3. Device according to claim 1, characterised in that it comprises a means (18) for manual control of the opening and closing of the valve system (14) for the selective passage, between the first and second ends (12, 13), of an evaporating constituent of the mixture to be evaporated.

4. Device according to claim 1, characterised in that the first and second connection ends (12, 13) and the body (11) are made from a metal material.

5. Device according to claim 1, characterised in that it comprises a plug-valve system (14).

6. Device according to claim 1, characterised in that it comprises a valve system (14) of the butterfly valve type.

7. Device according to claim 1, characterised in that it comprises a removable coupling (20) including a first portion (21) for connecting to the second end (13) for sealed connection to the reception container (2) and a second portion (22) with a diameter adapted for connecting the containment device (10) to the rotation shaft (3).

8. Device according to claim 1, characterised in that the body (11) is in the form of an assembly of at least two independent components that can be connected sealingly, each of the two components including one of the first and second connection ends (12, 13) and a valve system (14) for the selective passage of an evaporating constituent of the mixture to be evaporated between the two components of the body (11).

9. Device according to claim 1, characterised in that it comprises an outlet (23) for cleaning fluid for cleaning one of the ends of the containment device (10) when the containment device (10) is connected to the rotary evaporator.

10. Device according to claim 1, characterised in that the second connection end (13) comprises a safety valve (28) configured to reduce the pressure when there is overpressure in the reception container (2).

11. Rotary evaporator comprising a rotation shaft (3) for rotating a container (2) for receiving a mixture to be evaporated, characterised in that it comprises a containment device (10) according to claim 1, disposed between the rotation shaft (3) and the reception container (2).

12. Rotary evaporator according to claim 11, characterised in that it comprises a refrigerator (5), a container (9) for recovering the evaporated constituent and a valve device (26) disposed between the refrigerator (5) and the recovery container (9).

13. Rotary evaporator according to claim 11, characterised in that it comprises a refrigerator (5) and a container (9) for recovering the evaporated constituent, the recovery container (9) comprising a vacuum connection (27).
